(19) United States
(12) Patent Application Publication
(10) Pub. No.: US 2008/0010086 A1
(43) Pub. Date: Jan. 10, 2008

(54) Health financial needs calculator

(75) Inventors: Christine Skelly, West Hartford, CT (US); Vincent Yeehwa Sai, West Hartford, CT (US); Joan M. Roby, Killingworth, CT (US); Edith B. Stein, West Hartford, CT (US); Jodi I. Hill, Wethersfield, CT (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Aetna Inc.

(21) Appl. No.: 11/481,305

(22) Filed: Jul. 5, 2006

(51) Int. Cl. G06Q 10/00; G06Q 40/00

(52) U.S. Cl. 705/2; 705/4

(57) ABSTRACT

A system and method for determining an expected health care financial need for a period of time in the future, such as during retirement, is preferably an Internet-based system that collects certain data provided by an individual. The invention provides a customized result tailored to the collected data.

### FIELD OF THE INVENTION

This invention relates generally to the actuarial arts and sciences. More particularly, this invention relates to a system and method for enabling a customized estimate of expected financial needs for health care for a period of time in the future, such as during retirement.

### BACKGROUND OF THE INVENTION

Research shows that many people consider health care to be the most critical issue facing the country today, ranking ahead of concerns over the economy. Indeed, many rank the issue of health care to be as concerning as threats of terrorism and national security. Apart from issue of whether individuals currently have adequate health care coverage, the prospect for planning for future health care costs is an even more daunting task. Health care costs are often difficult to project for many reasons. First, projecting health care costs in the abstract may be likened to predicting the occurrence of a natural disaster. Certain expenses, such as health care premiums and deductible payments, may be planned for in the short term, since these may be established at annual enrollment. These are difficult to estimate longer term because they are dependent on premium cost sharing between employers and employees, medical and general inflation rates, and other factors. It is often difficult to estimate other expenses, such as non-covered medical expenses and long-term care expenses. In addition, health care costs have outpaced inflation for the past 20 years, and prices are projected to increase. Indeed, out-of-pocket health care expenses are currently growing at two to three times the rate of inflation.

Demographics also play a part in the issue of health care. Many baby boomers are nearing closer to retirement age. This large aging population segment is likely to have an impact on an already overwhelmed health-care industry. In response to this problem, more employers have had to restructure their retiree health insurance plans. This typically has resulted in declining retiree benefits from employers. Many retirees are finding that they now must give more in co-payments or pay higher premiums to cover spouses and dependents. Some have even lost their employer-sponsored health insurance altogether. And, many employees have never had an employer sponsored health plan and have no expectations beyond Medicare for coverage in their retirement.

Health status and lifestyle factors are also key determinates to health care costs. Chronic conditions, which can increase in severity over time, can also complicate other conditions. Lifestyle factors, such as weight, whether an individual smokes, drinks alcoholic drinks, has a high stress level, and exercises regularly, can also influence medical costs.

To exacerbate the problem, medical treatment approaches and procedures have become more complex, and as a result, more expensive. New treatments are being administered, and existing procedures are being performed, on a greater number of patients. A concomitant result is that life expectancies are also increasing.

Estimates of health care cost as a percentage of retirement income have heretofore been difficult to determine. Many consumers, therefore, have not adequately planned for health care expenses, especially during retirement. This is, in part, due to a general lack of understanding regarding Medicare, employer coverage during retirement and other available coverage options. Some now rely on financial planners and advisors to plan their retirement needs. However, financial planners, for their part, are not now equipped to address the requirements for health care, particularly with respect to long-term planning. Such costs are often difficult to quantify, particularly with respect to changes in the life situation of the consumer as well as the spiraling health care costs generally.

As a result, many individuals now grossly overestimate their expected long-term health benefits. Indeed, it is estimated that more than two-thirds of all U.S. citizens believe that their employer covers the health care expenses of its retirees. In reality, only one-third of U.S. employers actually do so. More than two-thirds of all U.S. citizens believe that Medicare will provide comprehensive coverage during retirement. This is also a misconception.

Various articles and publications have also addressed the need to adequately prepare for health care costs during retirement as part of a comprehensive retirement plan. For example, Fidelity Investments offers an Internet-based tool, which is available at the following address: https://powertools.fidelity.com/healthcost/personalInfo.do?doWait=1. This tool provides output estimates of health costs based on certain data provided by the user. Such data includes the user's planned age of retirement, whether the user has medical insurance currently provided by his or her employer, and other information. However, the output estimates are based only on static or fixed average data reference points. Therefore, the results provided by this tool are essentially the same for healthy and sick individuals alike.

Accordingly, prior art solutions do not now provide any customization of the estimates to account for an individual's particular life and health circumstances. These may include existing chronic conditions, family history, lifestyle habits and the like. Therefore, with the migration to more consumer directed health plans, a broad lack of health care literacy, uncertainty of health care coverage in the future and uncertainty of the future of the Medicare program, consumers need a method to increase their awareness of the factors which influence overall health care costs, including things in their control, such as lifestyle factors and retirement age, and things beyond their immediate influence, such as medical inflation, availability of employer provided coverage, and mortality rates, and factors that fall somewhere in between, such as impact of having a health plan and participation in disease management programs for chronic conditions. Such an educational tool can also provide a sense of the magnitude of the amount that may be needed to save for health care costs in the future and can suggest how to save for anticipated health care costs.

### SUMMARY OF THE INVENTION

The present invention relates to a system and method for increasing awareness of the factors which can determine an expected health-related financial need for a period of time in the future. In a preferred embodiment, the invention is a computer-implemented system and method for calculating an estimated financial need for health care that collects certain input data concerning attributes of an individual. These attributes may include demographic data, medical history and lifestyle factors. In this regard, one embodiment of the invention causes displaying a predetermined sequence of inquiries tailored to attributes of an individual that are used to determine the expected financial needs of the individual.

In response to the health-related attributes provided by the user, the system and method generates a current medical cost estimate for the individual, which is determined as an annual cost estimate or as an estimate for a period of years or some other time. The system and method then automatically applies inflation and savings rate, and optionally other predictive modeling factors, to the annual medical cost to generate a projection of long-term health care expenses for a particular duration, such as during retirement. In one aspect, the system establishes a long-term health care financial planning solution to enable the user to meet the estimated financial needs. In another aspect, the system associates the health planning proposal with other savings and/or insurance plans. While no one can predict with certainty actual costs in the future, or the impact of progression of chronic disease and medical conditions, an embodiment of the invention is used as a tool to educate the user on factors which can influence costs, and to increase awareness of the need to plan and to save for future health care costs.

### BRIEF DESCRIPTION OF THE DRAWINGS

FIG. 1 is a simplified block diagram representation of an Internet-based system that may be used in conjunction with a retirement health needs planning tool according to the present invention.

FIG. 2 is a flow chart illustrating user interaction with the Internet-based system of FIG. 1.

FIGS. 3A and 3B are flow diagrams illustrating a sequence of steps performed by the system to create a retirement health care cost estimate according to a preferred embodiment of the present invention.

FIGS. 4, 5 and 6 are screen displays illustrating a user interface of a retirement calculator tool according to the present invention.

FIGS. 7, 8 and 9 are further screen display illustrating a further user interface that presents results to received input information concerning predetermined attributes of the individual.

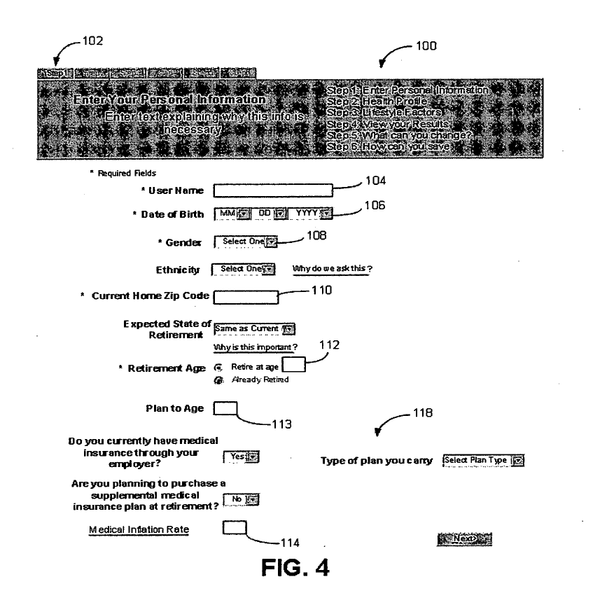

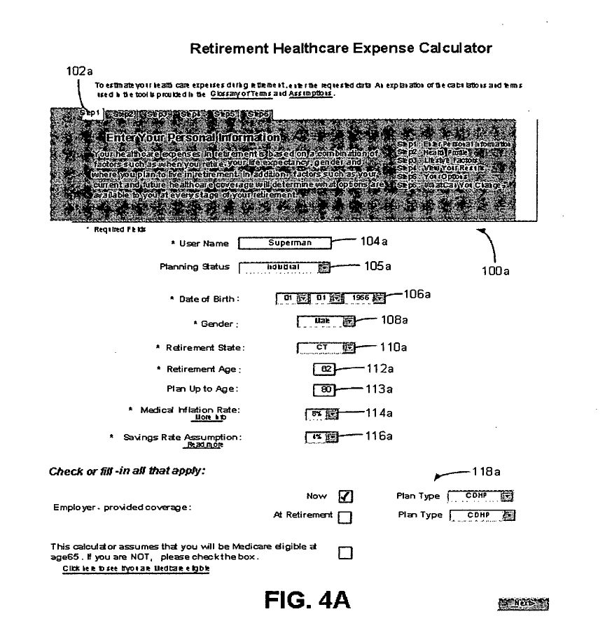

FIGS. 4A, 5A and 6A are screen displays similar those shown in FIGS. 4, 5 and 6 in that they illustrate a user interface according to another embodiment of the present invention.

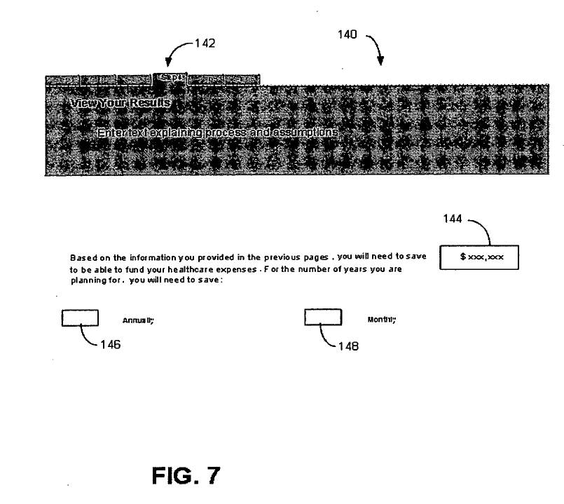

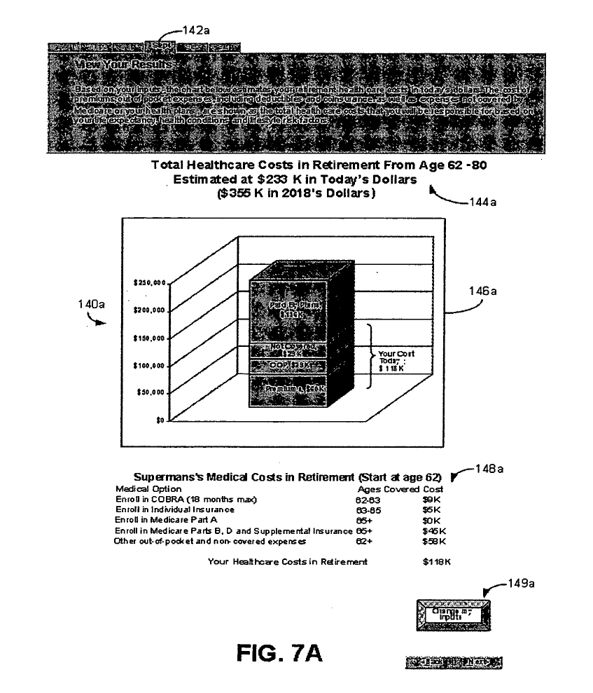

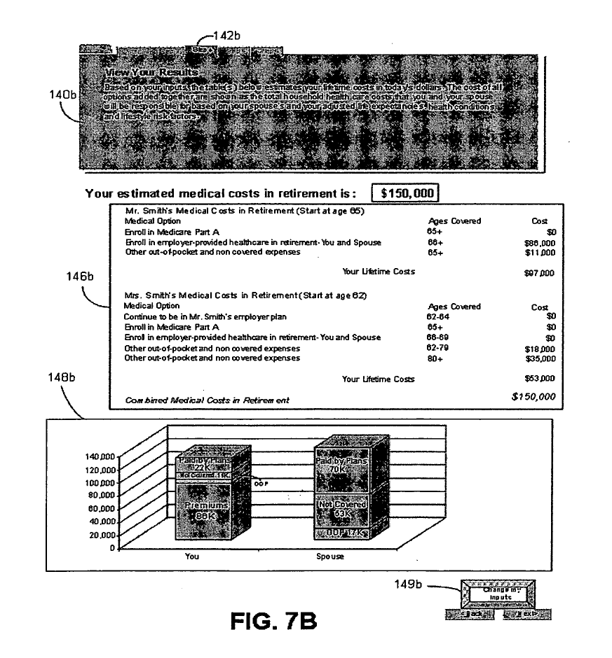

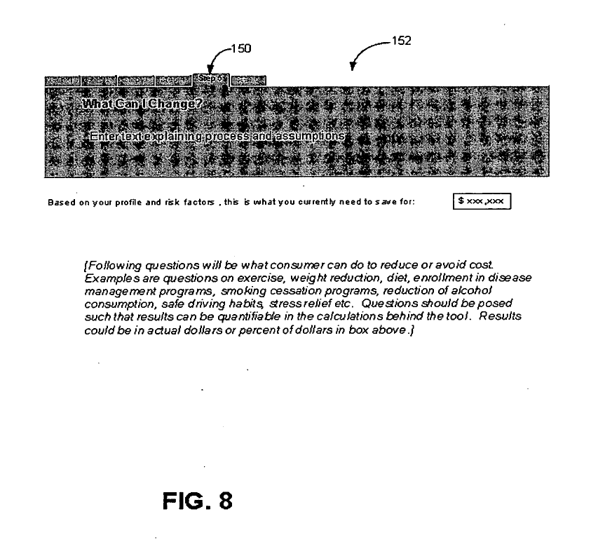

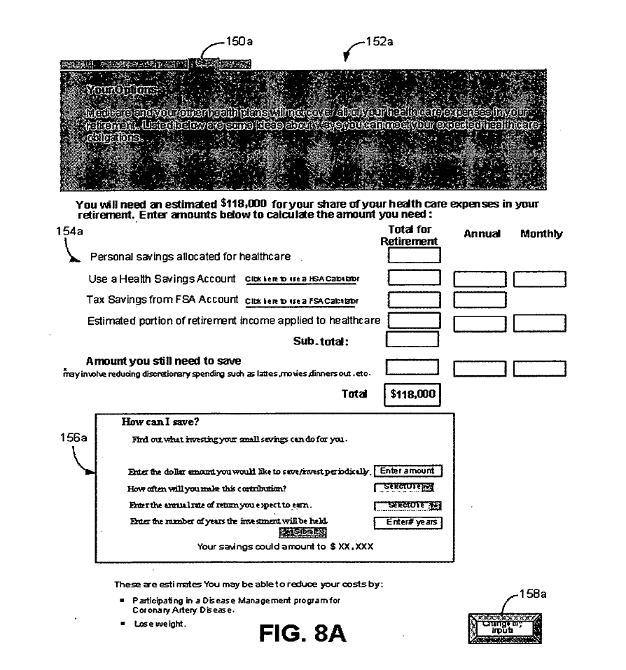

FIGS. 7A, 7B and 8A are screen displays similar to those shown in FIGS. 7 and 8 in that they illustrate a user interface that presents results to received input information according to another embodiment of the present invention.

### DETAILED DESCRIPTION OF THE PREFERRED EMBODIMENTS

Generally, the present invention relates to a system and method for estimating and calculating long-term health care spending requirements. The invention includes specifying particular attributes of a user. These may include health circumstances of an individual, such as specification of existing chronic health conditions, family medical history, lifestyle habits and other factors that may impact anticipated health care costs over time. The invention optionally includes specifying other health related information concerning the individual. The invention then applies factors based on predictive modeling data derived from statistical analyses of claims data, cost data or the like for a member group. In this way, the invention provides a customized estimate for an individual that may provide a more accurate predictor for the individual's long-term health expense requirements.

The following description of presently contemplated preferred embodiments is directed to functionality that is embodied in certain software and/or hardware implementations. However, those skilled in the art should appreciate that the invention is not limited to the specific hardware and/or software implementations described. Thus, for example, functionality that is described in terms of a software component or subcomponent could easily be implemented as one or multiple disparate software components that are executing on one or more computing systems. Similarly, software functionality that is described hereinafter as being implemented in computing systems that are connected in a client-server relationship over the Internet could just as easily be implemented in a single computing system or in an intranet environment with appropriate modification.

The following detailed description also uses terms such as “user,” “individual,” “consumer” and “customer” in conjunction with the invention. Those terms should be construed in their broadest sense to include a single person, one or more family members or any other entity for which long-term health care expenses are estimated.

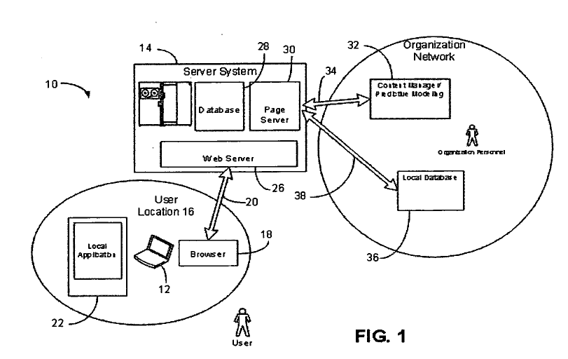

FIG. 1 is a block diagram illustrating generally certain features of an embodiment of the present invention. In this illustrated embodiment, a retirement health care expense calculator tool is implemented within the framework of a computing network 10. The computing network 10 comprises at least a first computer 12 and a server computing system 14. In this instance, the computing systems 12 and 14 are configured in a client-server relationship. The first computer 12 is a computing device such as an individual's desktop, laptop or the like. Typically, a user operates the computer 12 at his or her home, office or at any other desired user location 16.

In one embodiment, the user establishes a connection with the back-end computing system. In this instance, a browser 18, via connection with the server system 14 over a link 20, operates to present a series of HTML pages that contain predetermined queries to the user to elicit answers concerning certain attributes of the individual. Based on input provided by the user, the system 10 returns a result that is tailored to user-specific attributes. In the illustrated embodiment, when the invention calculates a retirement health-care expense profile, the result is presented in the form of a document, such as an HTML page, that includes an estimate of total health care costs for retirement. As explained in greater detail below, the output may further include one or more recommended financial planning solutions that are tailored to the user's particular needs.

The user provides input information pertaining to certain attributes or characteristics of the user that effect health care expenses. These may include the number of family members for which the estimate is being created, the user's age, gender, geographic location, medical conditions and history, health maintenance information, family medical history and other information. In addition, the user provides lifestyle information, such as amount of exercise and other user specific lifestyle factors.

Through interaction between the user and the system, the system creates an output page that provides a summary of estimated health care costs needed for retirement. The user may optionally obtain an estimate of long-range financial needs via an output document. Preferably, the output document contains relevant information for long-range financial planning. As explained in greater detail below, the output document is optionally electronically transmitted to the user.

In one embodiment, the output document contains information sufficient to provide a summary of estimated health care costs for retirement. That is, the output document may contain the following information: (1) a summary of the relevant assumptions obtained from the user; (2) a description of the overall costs; (3) a breakdown of anticipated long-term costs over discrete points in time; and (4) other information such as links to reference literature.

In an alternative embodiment, skilled personnel such as a financial planner, in consultation with a customer, interacts with one or more client application programs 22. In the illustrated embodiment, client application program 22 is a financial planning application running on the computer 12. The client application 22 hosts the web browser 18 (in-situ) to enable users to view web pages supplied by the back-end computing system or server 14. By way of example, the server may provide a presentment of inquiries, whereby users have a personalized web page sent thereto via which the users can see financial planning information. In one example, as represented in the partially-rendered web page 140 of FIG. 7, a representation 144 of a total calculated cost estimate may be generated for all retirement, another representation 146 for an annual savings requirement, and so forth. Note that although only one server system 14 is shown in FIG. 1, those skilled in the art will understand that the web pages may be distributed among many websites and/or servers.

In this alternative embodiment, when the client application 22 (e.g., on the computing system 12) hosts the browser 18, the client application 22 does not necessarily direct the browser 18 to a normally accessible page of the website hosted by the computing system 14. Instead, when a financial planner wishes to generate a detailed estimate as part of a comprehensive financial plan, the client application 22 may provide the hosted browser 18 with a URL (Uniform Resource Locator) of a hidden (out-of-band) page. The page can be kept hidden from the user by redirecting the browser to a second visible page after the hidden page has been downloaded. Essentially, only the client application 22 knows of this hidden page, although there are straightforward ways (e.g., via a client identifier) to ensure that only proper clients may use the hidden page. The client application 22 further may pass application data to the hidden page URL as part of the URL string it passes to the browser 18 when requesting access thereto.

In accordance with another aspect of the present invention, the server 14 may consider the client application 22 an enhanced application, such as through accessing a hidden page or the like. To identify the client application 22 as enhanced, the system may write client awareness data such as a cookie through the web browser 18. In this way, the user need not be aware that a connection has been established with the server 14.

The computer 12 is linked by way of one or more network connections, such as the connection 20 established by the browser 18, to the server computing system 14. In a preferred embodiment, the computing system 14 includes one or more physical and/or logical entities. The computing system 14 may be linked to the first computer 12 through any appropriate public or private network connection. As shown, the computing system 14 is also configured to communicate with various parts of an organization, in this case an insurer. In the illustrated embodiment, the system 14 includes one or more web servers, such as an illustrated web server 26, for providing functionality such as creating and managing network connections and processing requests provided from other computing devices in the network.

In addition, the system 14 includes a database or data store 28 that provides a repository of information that is accessed to implement various predictive models according to the invention. In a preferred embodiment, the database contains entries relating to various actuarial tables, previously generated estimates that have been provided, and predictive models based on control group information. Such information is used in generating a retirement health financial needs estimate, as explained in greater detail below.

Also, the computing system 14 may be configured to include one or more page servers, such as illustrated page server 30, for processing requests received and routed thereto from the web server 26. While the page server 30 is implemented as a separate physical computing device in one embodiment, appropriate functionality may included with the web server 26 in a single physical device. The page server 30 may include and/or access data sources, such as the data store 28, that are used to calculate the retirement health financial needs estimate. The web server 30 may also be configured to access provide graphics templates, document templates and update information. Such templates may be used for generating financial planning document proposals in a desired format, such as HTML, Portable Document Format (.pdf) or other desired format. Alternatively, relevant data may be returned to the computing system 12 in any appropriate format, i.e., in XML format, such that the documents are created at the computing system 12.

Thus, the input information used to create a retirement health financial needs estimate is transmitted to the back-end system 14 in a preferred embodiment. As noted above, the back-end system 14 includes or is linked to a database 28 and a page server 30. At the server 14, the extracted user attribute data is passed to the page server 30 for processing thereof. From information including actuarial tables and/or other predictive modeling data, the page server 30 generates a document file that may comprise an estimated retirement health financial needs analysis. The document file is transmitted back to the first computer 12 by way of the network connection 20.

Other computing devices and systems within an organization are preferably interconnected with the server computing system 14. FIG. 1 illustrates various computing functions that are interconnected with the server system 14 either via a network connection or otherwise. For example, an organization network may include a content manager 32. From this component 32, information technology or other personnel may maintain the server 14. For updating predictive modeling and servicing the records maintained in the database 28 and/or page server 30, the content manager 32 is coupled via a network connection 34 to the server system 14.

The organization network may also include a local database 36 that is accessible by other departments of the organization. In one alternative embodiment, the database 36 may include information that is otherwise input by users, such as demographic information, medical information, test data, insurance claims data, Health Risk Assessment profile information and the like. Upon receipt of a request to generate an estimate, the local database 36 provides access to various pieces for automatically creating certain cost factors without the need for user input. Advantageously, this embodiment provides automated generation of user input information based on already maintained data sources concerning the user.

Therefore, the invention may be employed in the context of various cooperating groups that are integrated within an organization, as shown in FIG. 1. However, those skilled in the art should appreciate that the various entities may be loosely coupled with each other such as through strategic partnership relationships and the like.

In addition to a calculated estimate, other materials, such as documentation relating to a proposed financial plan, may be similarly generated and returned to the user computer 12 in response to appropriate requests. In this way, one or more proposed financial products may be uploaded from the first computer 12 by a salesperson. Information relating to the financial product is also transmitted to appropriate persons or divisions of the firn.

In accordance with one aspect of the present invention, a computerized expert system enables a user to easily specify his or her attributes to obtain a detailed estimate of retirement health financial needs, making the retirement financial planning process easier while achieving substantial peace of mind for the user. The user is guided through a question process that takes the form of questions and selectable options that are presented to the user by way of an intuitive graphical user interface. The interface is presented in a way that enables navigation by unsophisticated users, and for sales personnel to access without interrupting discussion of financial planning needs with customers.

In particular, by clicking on appropriate buttons presented on the page or sequence of pages with a mouse or other pointing device, the user causes the system to display buttons, pull-down menus or content in which the user can supply input responses. In one embodiment, additional questions may be presented by the system based on answers supplied by the user to particular questions. Algorithms and logic associated with the interactive attribute specification process permit a realistic evaluation and estimation to be made.

For preparing an estimate of health-related financial needs during retirement, the browser issues requests and passes data, by way of a network connection 20, to the web server component 26 maintained at the server system 14. As described above, this component, in conjunction with the database 28, and page server components, processes the received requests and data. Among other things, these components operate to determine various risk factors associated with the user and calculate a retirement health financial needs estimate. In addition, the server system 14 accesses various templates. Such templates are used for generating proposal documents in a desired format, such as HTML format. The templates preferably include information related to the customer, retirement need details, and optionally financial planning information that are automatically returned to the user computing system 12.

In accordance with one aspect of the invention, the system and method performs various analysis and risk factor generating steps to automatically complete a customized health-related cost estimate. The method steps according to the invention may be performed through processing the responses to a series of pre-selected queries provided by the system to a user.

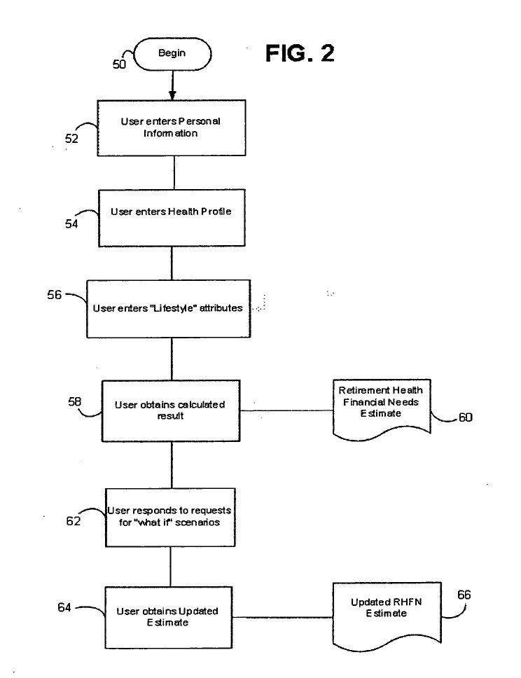

FIG. 2 illustrates a preferred implementation of the invention for automatically generating an estimate of financial needs during retirement as a result of input provided by a user. In the illustrated embodiment, the process begins at a block 50, as shown in FIG. 2. The method proceeds to a next step 52 in which a user supplies personal information that is used by the system to create a preliminary health needs estimate for a healthy individual. As shown in the partial rendering at FIG. 4, such personal information includes the person's name, age, gender and geographic location. For entering such information, the user operates a local computer (such as the computer 12 shown in FIG. 1) in accordance with application programs running thereon. In one embodiment, the user interacts with a browser 18 that enables communication with a server system 14 to provide content, which includes a series of queries that elicit the information provided by the user. In another embodiment, the user interacts with other local applications 22 that provide a hosted browser with appropriate address information.

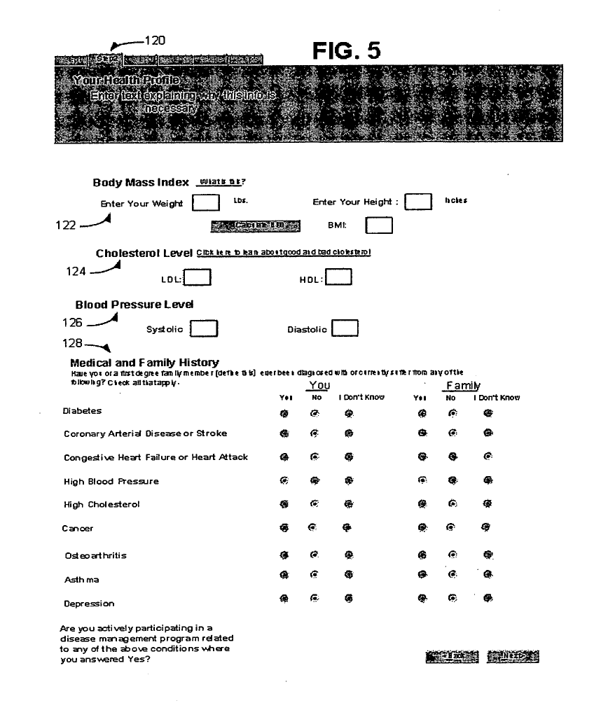

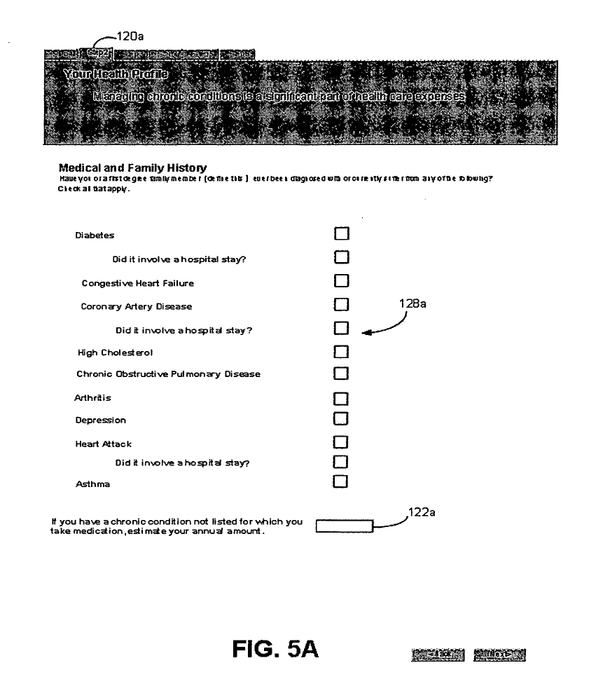

At a next step 54, the user enters health profile information. One exemplary profile is shown in a partially rendered web page at FIG. 5. At this step, information associated with any chronic health conditions for the individual is provided by the user. The data is similarly passed via the web server 26 to the page server 30 for processing, as explained below. This enables the system to make appropriate adjustment for any adverse health conditions that effect long-term health needs.

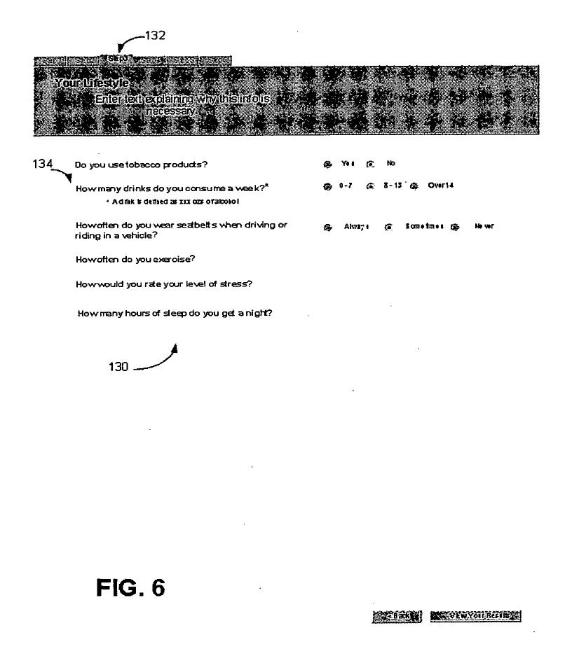

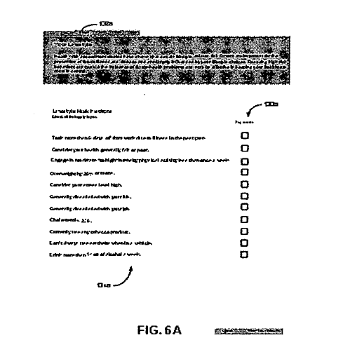

Once the relevant information concerning the user's health profile has been entered, the user enters “Lifestyle” attribute information at a next step 56. As shown in the partially rendered web page at FIG. 6, such Lifestyle information includes responses to whether the user consumes tobacco products and alcohol, level of exercise, stress level and hours of sleep per night. As explained below, this information is used by the system to customize the retirement health financial needs estimate based on predictive modeling analyses used by the system. As shown in FIG. 1, the browser 18 typically supplies the Lifestyle attribute data via network access to the server system 14. Once the input information is provided, the server system 14 saves the information in the central database 28.

Upon transmission of the individual's input information, the user provides a request to view the results. Specifically, at a next step 58, the user may issue a request to obtain an estimate of retirement health financial needs. As a result, the user may view a calculated estimate 60. The calculated estimate 60 may be presented as shown in the partial rendering of a web page at FIG. 7.

The user may also access additional queries that concern changes to the assumptions used to determine the estimated retirement financial needs estimate 60. For example, at a next step 62, the user enters responses to queries relating to ways in which the cost may be reduced or avoided (see FIG. 8). These responses are transmitted to the server system 14 and the estimate is recalculated. As a result, at a next step 64 the user is presented with an updated financial needs estimate 66. In a preferred embodiment, the planning tool according to the invention provides the ability to change any previously input variable to generate a new set of outputs. This provides a “what if” scenario capability. One or more changed scenarios may be displayed next to the first calculated estimate. Different scenarios determined as a result of different user input variables may be named and stored in the user computer 12, the database 28 or elsewhere and recalled at a later time.

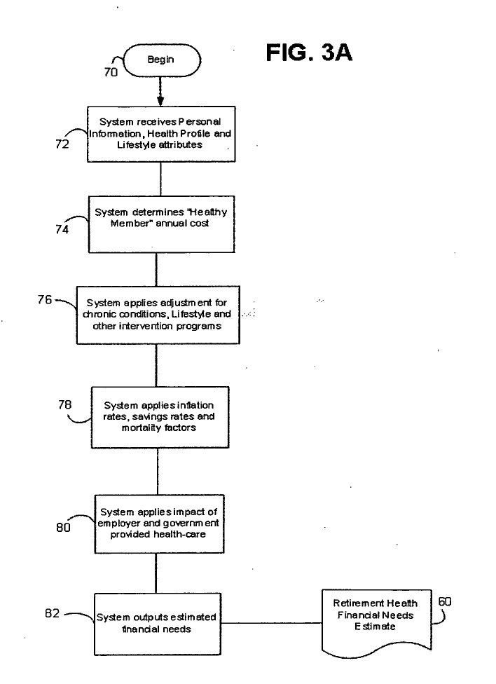

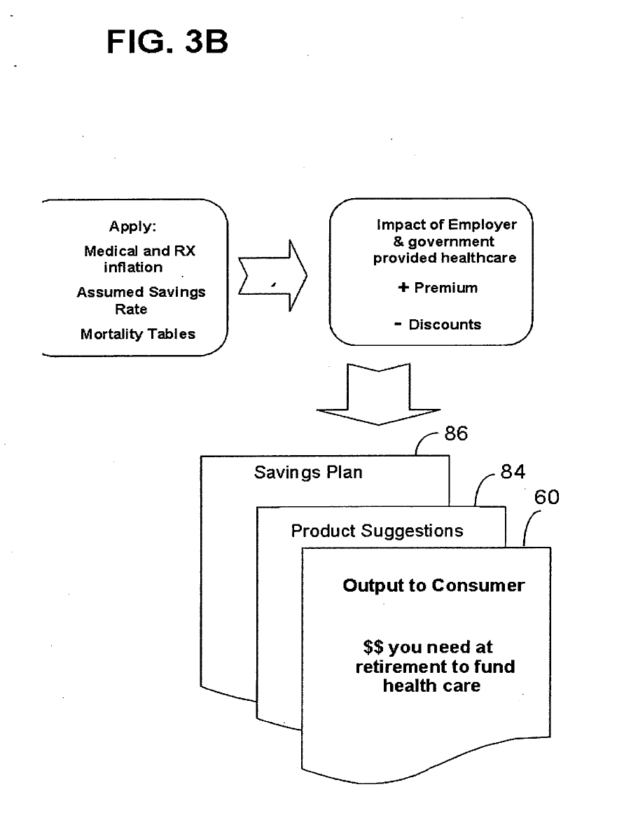

FIGS. 3A and 3B illustrate a preferred sequence of steps for implementing the invention at the server system 14. As shown in FIG. 3A, the system begins a step 70 and proceeds to a next step 72. At the step 72, the system receives consumer input information concerning the user. As shown in FIG. 3B, such information includes gender, age, location (zip code), and an identification of chronic health conditions. In addition, the system receives input concerning certain lifestyle conditions, any health risk abatement programs in which he or she participates, and the available balance in any tax advantaged savings plan, such as a Health Savings Account. Finally, the system receives information concerning current and post retirement health plan provisions as well as eligibility for government programs, such as Medicare or Medicaid, at retirement. Additional information may also be provided by the user, such as genetic predisposition to certain disease or other factors that may be utilized by the system to predict future health care cost.

For calculating the health-care expense estimate, the invention relies on various predictive models for future behavior to determine an appropriate risk factor to apply to a current expense amount. While certain predictive models are used to implement a preferred embodiment of the invention, those skilled in the art will appreciate that one or more additional or alternative predictive models may be implemented that do not specifically use the components described below or that implement the components in different ways. Importantly, however, the invention calculates a future health-care expense estimate according to a predictive model that customizes the result based on one or more attributes of the user, in essence, capturing the user's life situation.

Based on the received data, the system first determines a current annual medical cost estimate at a next step 74. That is, the system determines a baseline case that is based on a definition and criteria for an individual that has no diagnoses for one or more enumerated chronic medical conditions. In essence, the baseline case does not necessarily relate to an individual without any disease. Instead, the baseline case refers to an individual that has not been diagnosed with one or more enumerated chronic medical conditions for a prescribed time period. Also, a “chronic” disease condition should not be understood to mean that the disease condition is indeed chronic. Rather, that term is merely used to refer to a disease condition that is enumerated by the planning tool as having an adverse impact on future health care cost. From these data, the invention derives an average “healthy member” cost based on age, gender, and geographic location, either region or state or both, where the user lives or intends to live in the future, such as in retirement. This calculation is a static calculation based on a static claims data tables or like information as will be understood by those skilled in the art. In a preferred embodiment, the invention then adds average health care costs that are estimated based on chronic conditions of the user.

In order to provide a customized health-related needs estimate tailored to the user, the invention applies various risk factors to a calculated annual health care cost value. Specifically, as shown at a next step 76 in FIG. 3A, the system applies adjustments to the current annual medical cost for the individual based on several factors. As best seen in FIG. 3B, the system determines an adjustment for medical and pharmacy costs associated with identified chronic medical conditions. This adjustment may be derived from a further predictive model derived from the cost associated with certain chronic conditions. Specifically, an embodiment of the invention accesses a static claims data table to determine the appropriate adjustment. This claims table is essentially disease specific and refers to a one-year average of medical and pharmacy cost with respect to a particular group, such as members of an insurance group. While it includes both medical costs and pharmacy drug costs with respect to the condition, other distinguishing factors are alternatively used to define the claims data table. Also, a regional cost factor is determined based on the location where the user lives or intends to live.

The system may also use a predictive model that is based on co-morbidity factors. In this regard, co-morbidity refers to selection by the consumer of more than one of the enumerated conditions. This co-morbidity factor is quantified as a result of predictive analysis that attempts to consolidate individual co-morbid conditions into a predictive variable that measures cost outcomes.

In accordance with one feature of the invention, cost impact factors based on lifestyle are also derived. While such lifestyle impact factors may be obtained from various methodologies, in a preferred embodiment, such lifestyle factors are obtained and dynamically updated over time. They are based on statistical analyses of group data to determine health cost impact based on such lifestyle factors. In this way, the invention obtains a realistic predictive variable with respect to such lifestyle factors as smoking, alcohol consumption, Body Mass Index, stress, exercise and other factors. As shown in FIG. 3B, the current annual medical cost estimate is adjusted upwardly or downwardly based on such Lifestyle attributes.

As shown in FIG. 3B, the system also adjusts the current annual medical cost estimate based on of any savings due to disease management or other health intervention (or “wellness”) programs identified by the user. Thus, for example, in the case where the user is a member of a disease management program, the annual cost for health care would be appropriately adjusted. Similarly, depending on the amount and comprehensiveness of the user's health care plan, the invention consults appropriate actuarial tables.

In the preferred embodiment, the invention therefore utilizes data obtained as a result of research on various models of human behavior, such as strain-strain-vitality relationships, the determinants of exercise and other behaviors, precursors to disease, precursors to vitality, and the logic and appropriateness of “wellness” programs. Such data may be collected by either one or more members of the organization or from external sources. In this way, the predictive modeling based on lifestyle may be implemented as dynamic process.

Accordingly, after the current annual health-care cost value is determined, the system proceeds to a next step 78 shown in FIG. 3A. At step 78, the system calculates a total cost estimate based upon projected medical and/or pharmacy cost inflation rates. In one alternative embodiment, such inflation rates are tailored to projected disease-specific inflation rates and/or projected inflation rates for different levels of care (e.g., local hospital care, tertiary care center, primary care physician, specialist, and the like.) In addition, the system applies assumed savings rates and mortality rates to the health-care cost value. For obtaining medical and pharmacy inflation rates from which to derive an appropriate present value formula, actuarial tables and other trend analyses may be utilized.

At a next step 80, the system thereafter utilizes a predictive model based on employer and government provided health care premiums and discounts. Finally, at a step 82, the system provides the retirement health financial needs estimate 60. In a preferred embodiment, the estimate represents the amount a user will need at retirement in order to fund health care of his or her choice. As shown in FIG. 3B, the system may further provide product suggestion documents 84 and/or savings plan documents 86. These documents aid in providing information concerning ways in which the user may reach the user's financial goals.

For simplifying and automating the retirement health-care needs planning process, the browser 18 includes a user interface that presents various selectable screen displays to the user. In an illustrated embodiment, the screen displays present a Windows based interface for logically guiding the user through the planning process. As shown in FIG. 4, a preferred user interface 100 in the form of a partially rendered web page has a layout that includes various icons, buttons, tabs, drop-down menus and other user-selectable fields adapted to receive input information relevant to the estimate calculator.

Specifically, the user interface 100 may include a user selectable Introduction (or “Step 1”) tab 102 that presents an initial screen for the retirement health financial needs calculator tool. This screen display includes fields for entering customer information. For example, in the illustrated embodiment, a customer name field may be presented in the form of a data entry field 104. In addition, the screen display includes required data entry fields for date of birth 106, gender 108, current home zip code 110, an anticipated retirement age 112, and a “Plan to Age” field 113. As noted above, such information is used by the system to generate a baseline annual medical cost estimate. For determining the effect of inflation due to medical costs, the screen display includes a Medical Inflation Rate field 114, which may be preset to a desired inflation rate. In addition, the user interface presents queries and responsive data fields 118 relating to current medical plans and any supplemental medical insurance that the user anticipates purchasing at retirement. Other optional data field may also be presented as shown.

FIG. 5 illustrates a screen display that is presented upon selection of a “Step 2” or Health Profile tab 120. For obtaining information concerning the overall health of the user, the screen presents data entry fields 122 (including height and weight) of the user to enable calculation of the user's Body Mass Index. This screen display also presents input boxes 124, 126 for entering the user's cholesterol level and blood pressure level. Also, the screen display shown in FIG. 5 includes lists of selectable buttons (denoted generally by numeral 128) concerning the user's medical and family history. In this way, the system obtains information concerning any chronic disease conditions or risk thereof.

In accordance with the invention, an expert system calculates a needs estimate that is specific to the customer's life situation. As shown in the partially rendered web page in FIG. 6, the user is guided through a series of questions that elicit information concerning lifestyle attributes. This page 130 is accessed via selection a “Step 3” or Lifestyle tab 132.

For providing Lifestyle attributes, the user is presented with a series of questions. As a non-exhaustive example, the user is asked to respond to questions 134 such as whether tobacco products are used, what amount of alcohol is consumed on weekly basis, whether the user wears seatbelts when driving or riding in a vehicle, how often the user exercises, how he or she rates the amount of stress, and how many hours of sleep the user gets per night.

As noted above, the application program 22 shown in FIG. 1 may alternatively instantiate the browser, such as when a financial planner or other individual instantiates the same. In this embodiment, the input information elicited through the screen displays shown in FIGS. 4 through 6 may be obtained in various other ways. Indeed, if it is already available through other data sources, the system may bypass certain steps in the interactive data collection process or may bypass the process altogether.

After the user is guided through various screen displays to aid in the entry of information needed to calculate the needs estimate, the expert system may then present the user with a logical series of results and further interactive queries, such as is shown in the screen displays of FIGS. 7 through 9. As with the input displays, the various output displays are accessed by the user through selection of tabbed pages.

FIG. 7 illustrates a screen display 140, which in this case is also a partial rendering of a web page, for providing the user with an interface for viewing the calculated retirement health needs estimate. This page is accessed via selection of a “Step 4” or View Your Results tab 142. In the illustrated embodiment, the calculated result is presented in a data field 144 that corresponds to a total amount the user will need to save in order to fund healthcare expenses during retirement. In addition, the View Your Results page 140 includes an annual savings requirement output data field 146 that is a calculation of the annual amount the user will need to save. Finally, the results page 140 includes a monthly savings requirement data field 148 that is a calculation of the monthly amount the user will need to save.

The expert system may include further screen displays to enable the user to conduct “what if” scenarios. Advantageously, the system recalculates the retirement estimate based on one or more changed assumptions to provide an updated retirement health financial needs estimate. In the illustrated embodiment, upon selection by the user of a “Step 5” or “What Can I Change” tab 150, the system may present a further screen display in the form of a partially rendered web page 152 shown in FIG. 8. This display 152 enables the user to conduct various “what if” scenarios to thereby reduce the estimated needs amount. For example, the system may implement these hypothetical scenarios through an interactive session in which the user provides responses to various queries that are intended to reduce the risk of long-term health care costs.

Preferably, the queries are set forth in such a way that a quantifiable updated result may be calculated and returned to the user. In this regard, the user may be guided through a series of questions posed such that elicited responses are quantifiable in the calculations performed by the system. By way of example, the system may pose questions and/or provide hypothetical scenarios concerning increased exercise and weight loss for discrete amounts. In this regard, the system may calculate an updated estimate based on hypothetical scenarios as input by the user. Also, system may offer scenarios, and optionally updated estimates, as a result of enrolling in smoking cessation programs, disease management programs, reduction of alcohol, stress relief, and the like.

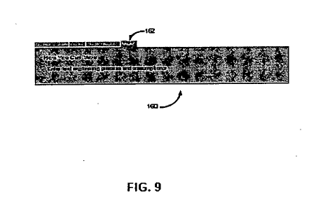

Finally, FIG. 9 illustrates a screen display 160, accessed via a user selectable “Step 6” tab. The screen display 160 provides additional background information concerning the retirement planning tool. Among other things, this display explains the estimation process and assumptions made by the system to generate the result.

FIGS. 4A, 5A, 6A, 7A, 7B and 8A illustrate a second embodiment of the present invention. As shown in FIG. 4A, a user interface 100a include a user selectable Introduction (or “Step 1”) tab 102a that presents an initial screen for the retirement health financial needs calculator tool. As with the embodiment disclosed above, this screen display also includes fields for entering customer information. For example, a customer name field is presented in the form of a data entry field 104a. The screen display includes required data entry fields for planning status 105a, date of birth 106a, gender 108a, anticipated retirement state 110a, anticipated retirement age 112a and a “Plan Up to Age” field 113a. As with the above embodiment, such information is used by the system to generate a baseline annual medical cost estimate. The user interface further presents a Medical Inflation Rate field 114a as well as a Savings Rate Assumption field 116a. In addition, the user interface presents queries and responsive data fields 118a relating to current medical plans and any supplemental medical insurance that the user anticipates purchasing at retirement. Other optional data field may also be presented as shown.

FIG. 5A shows a screen display that is presented upon selection of a “Step 2,” which in this case is a Your Health Profile tab 120a. To obtain information concerning chronic health conditions of the user, the screen presents a data entry field 122a and a listing of selectable buttons (denoted generally by numeral 128a) concerning the user's medical and family history. In this way, the system obtains information concerning any chronic disease conditions or risk thereof.

In the screen display shown in FIG. 6A, the user is guided through a series of Lifestyle risk factors intended to elicit information concerning lifestyle attributes of the user. This page 130a is accessed via selection a “Step 3” or Lifestyle tab 132a. In the illustrated example, the user is presented with a series of Lifestyle risk factors 134a such as how many days were missed from work within the past year, amount of exercise, whether the user is overweight, general job and life satisfaction, whether tobacco products are used, what amount of alcohol is consumed on weekly basis, whether the user wears seatbelts when driving or riding in a vehicle, how often the user exercises, how he or she rates the amount of stress, and how many hours of sleep the user gets per night.

The system then presents the user with a logical series of results and further interactive queries, such as is shown in the screen displays of FIGS. 7A, 7B and 8A. As with the input displays, the various output displays are accessed by the user through selection of tabbed pages in the illustrated embodiment.

FIG. 7A is a screen display 140a, in this case a partial web page rendering, for providing the user with an interface for viewing the calculated retirement health needs estimate. This page is accessed via selection of a “Step 4” or View Your Results tab 142a. In this alternative embodiment, a calculated total healthcare costs result is presented in various formats. First, the total costs estimate is presented in a Summary format 144a (in both today's dollars and dollars at retirement). In addition, the total costs estimate is presented in a graphical format 146a that provides a detailed breakdown of a total estimated amount the user will need to save in order to fund healthcare expenses during retirement. In addition, the total cost is displayed in a Medical Costs in Retirement field 148a for the relevant ages covered. In this embodiment, the screen display 140a includes a Change my Inputs button 149a which, upon user selection, returns the user to the appropriate input screen and then recalculates the estimated costs.

FIG. 7B is a further screen display 140b, in the form of a partially rendered a web page, for providing the user with an alternative interface for viewing the calculated retirement health needs estimate. This page is rendered in a table format, and is similarly accessed via selection of a “Step 4” or View Your Results tab 142b. In this embodiment, the system presents a calculated total healthcare costs result as a total estimated medical costs 144b. The illustrated tabular format 146b provides a detailed summary of cost components that were tabulated to obtain the total estimated costs. The system in this example also provides a graphical display format 148b for presenting the results in slightly differently. The screen display 140b also includes a Change my Inputs button 149b which, upon selection, returns the user to the appropriate input screen and then recalculates the estimated medical costs.

FIG. 8A shows a screen display, in the form of a partially rendered web page, accessible via selection of a “Step 5” tab 150a. This “Your Options” screen display 152a provides further calculators that enable the user to determine how to allocate resources in order to meet his or her estimated costs amount. The screen display 152a presents one or more financial plans, such as a Health Savings Account or the like, that may be utilized to achieve the estimated costs amount. A “How can I save” screen area 156a provides the user with further investment options, such as through regular contributions to a financial investment. As with the screen displays described above, the screen display 152a includes a Change my Inputs button 156a which, upon user selection, returns the user to the appropriate input screen and then recalculates the estimated costs.

The planning tool may thus present various “call to action” output in addition to the estimate or projection of costs. In one embodiment, the planning tool provides one or more suggested insurance product solutions that will provide coverage through the retirement years (or for any other period). Alternatively, or in addition, the tool offers suggestions on how the user can control future health costs. For example, the tool may explain how to control costs through lifestyle changes and/or through disease management programs. Finally, the “call to action output” includes solutions on how to save money to meet the estimated future financial need. These are sometimes implemented as simple practical solutions, such as foregoing an unnecessary daily or weekly expense. The planning tool may further include hyperlinks to other financial tools and/or embedded calculators for providing financial planning information to the user.

The output is further presented to the user with a confidence level in one embodiment. For example, a Monte Carlo simulation is applied to the estimate of projected costs to further refine and provide confidence levels in the generated estimate. Other statistical analyses may be applied to the estimate to provide a further confidence level to the user.

As explained above, the planning tool is integrated into financial planning software in one embodiment. This embodiment provides a feature of user access to appropriate financial products and/or programs to enable the user to meet the estimated future financial need. In this way, the planning tool may be used in conjunction with projected investment returns to achieve long term financial planning. Also, the planning tool may be used to develop appropriate spend-down planning of retirement savings when the user reaches or is near retirement.

Accordingly, a system and method meeting the aforestated objectives has been described. The system provides a software tool for determining a customized health care expense estimate a future time period, such as during retirement or for some other duration. The estimate is provided as a result of user input concerning the health and lifestyle of an individual, which may be input in response to a series of queries for guiding the individual or a financial planner through the estimation process. The estimate is calculated through the application of various risk factors derived from, among other things, control group data obtained by the system. In this way, the system calculates an estimate customized to the particular user's life situation. The system advantageously provides improved information concerning long-term health care cost solutions, while substantially reducing the amount of guesswork and the time for providing such an estimate.

Those skilled in the art should appreciate that the invention is not intended to be limited to the above described currently preferred embodiments of the invention. Various modifications will be apparent, particularly upon consideration of the teachings provided herein. For example, the information concerning an individual may be provided in an automated process, such as when the system can access such data from other available sources. This embodiment does not require questions and answers to be provided to, and received from, the individual. Of course, when only certain input information is available from alternative data sources, the invention may be tailored to request a subset of information only, such as requests for entry of lifestyle habits only when other health status information is already known. Additionally, while the presently preferred embodiment of the invention is described with respect to accounting for certain disease conditions and lifestyle factors, the invention is not intended to be so limited. To the contrary, the invention is intended to encompass estimating future health care financial needs by accounting for any dynamic factor that will change the probable level of future expenses. Thus, any number of other known facts concerning health status, such as diseases, conditions, insurance claims data, lab values, weight, blood pressure and other health facts, genetic variations, family history, exercise level, family status, work hours and other life events, may be employed. Similarly, future occurrences that might influence the probabilities, such as changes in any of the above factors or receipt of prophylactic treatment with respect thereto, may also be used.

Also, certain functionality that has been described in conjunction with software components of the system. These may be combined with other components, or alternatively, be implemented in numerous other ways, whether by other software and/or hardware implementations. Also, although the invention has been described in the context of interactions of various computing systems in a network configuration, those skilled in the art will recognize that many other configurations may be employed. Thus, the invention should be understood to extend to that subject matter as defined in the following claims, and equivalents thereof.

What is claimed is:

1. An interactive software tool disposed to generate long-term health care expense information, comprising:
a browser, executing on a first computer, disposed to receive input information specifying attributes of a customer, the attributes including lifestyle attributes, and for transmitting the input information; and
a server computing system, linked with the first computer, disposed to receive the input information, for determining a current annual medical cost from the input information, for applying first risk factor to the current annual medical cost based on the attributes of the customer, for applying a cost inflation factor to an expected cost of medical care, and for generating an output relating to a customized health care expense estimate.

2. The invention as in claim 1 wherein the output is a retirement health-care expense estimate.

3. The invention as in claim 2 wherein the customer attributes includes an identification of any chronic conditions of the customer.

4. The invention as in claim 3 wherein the customer attributes includes an identification of any disease management program in which the customer is engaged.

5. The invention as in claim 4 wherein the current annual medical cost includes a pharmacy cost.

6. The invention as in claim 5 wherein the wherein the server computing system applies an expected inflation factor to the pharmacy cost.

7. The invention as in claim 6 wherein the wherein the server computing system further provides output data indicating a long-term financial plan.

8. The invention as in claim 7 wherein the wherein the server computing system further provides output indicating financial product offerings consistent with the long-term financial plan.

9. The invention as in claim 1 wherein the server computing system comprises:
a web server disposed to facilitate communication with the browser;
a central database containing entries relating to cost impacts based on lifestyle attributes obtained from a control group; and
a page server disposed to access the central database and to facilitate processing of the customized health care expense estimate.

10. The invention as in claim 9 further comprising:
a local financial planning application, in communication with the browser, disposed to receive the input information, to parse the input information, and to pass the information to the browser.

11. A method for generating health care expense estimates for a future time period, comprising:
receiving input information specifying attributes of a customer, the attributes including lifestyle attributes for the user;
determining a current annual medical cost estimate based on the received input information;
applying a first risk factor to the current annual medical cost estimate based on the attributes of the customer;
applying a cost inflation factor to the current annual medical cost estimate to calculate a result; and
calculating a customized health care expense estimate based on the result.

12. The invention as in claim 11 wherein the health care expense estimate is a retirement health-care expense estimate.

13. The invention as in claim 12 further comprising the steps of
presenting the customer with a request to specify modified customer attributes;
receiving modified customer attributes from the user; and
calculating an updated health care expense estimate based on the modified customer attributes.

14. The invention as in claim 12 wherein the customer attributes include an identification of chronic disease conditions of the customer.

15. The invention as in claim 14 wherein the customer attributes include an identification of a disease management program in which the customer is enrolled.

16. The invention as in claim 15 wherein the step of determining an annual medical cost includes determining a pharmacy cost, and
adding the pharmacy cost to the annual medical cost.

17. The invention as in claim 16 further comprising the step of applying an inflation factor to the annual pharmacy cost.

18. The invention as in claim 17 further including the step of providing an output indicating a long-term financial plan.

19. The invention as in claim 18 wherein the output further identifies financial product offerings consistent with the long-term financial plan.

20. The invention of claim 19 wherein the output is automatically generated.

21. An Internet-based retirement health financial needs estimator tool comprising:
a first software component including a set of executable instructions for receiving a plurality of user attributes, at least one of the user attributes relating to a lifestyle circumstance for the user; and
a second software component including a set of executable instructions for determining an average annual health care cost for a baseline case, for applying a risk factor to the baseline case based upon the plurality of user attributes, for applying a projected inflation factor to the baseline case, and for generating a customized health care expense estimate based on the result.

22. The invention as in claim 21 wherein the first software component executes on a first computing system and the second software component executes on a second computing system, and wherein the estimator tool further comprises:
a communications module for establishing a link between the first computing system and the second computing system, wherein the second computing system is disposed to receive the user attributes transmitted by the first software component via the communications module, to process the user attributes to generate an output relating to the customized health care expense estimate, and to cause the first software module to display the customized health care expense estimate.

23. The invention as in claim 22 wherein the customized health care expense estimate is presented as part of a financial planning document generated in a standard format.

24. The invention as in claim 23 wherein the financial planning document includes at least portions thereof provided in XML format.

25. The invention as in claim 24 wherein the financial planning document relates to a financial product.

26. The invention as in claim 22 wherein the first software component displays a sequence of queries organized as a plurality of work sheets, wherein each of the work sheets is accessible via user actuation of an associated tab.

27. The invention as in claim 26 wherein at least one of the plurality of work sheets presents input fields concerning the age, gender and geographic location of a user.

28. The invention as in claim 26 wherein at least one of the plurality of work sheets presents a series of queries concerning a health profile for the user.

29. The invention as in claim 26 wherein at least one of the plurality of work sheets presents a series of queries concerning lifestyle attributes for the user.

30. The invention as in claim 26 wherein at least one of the plurality of work sheets specifies the customized health care expense estimate.

31. The invention as in claim 26 wherein at least one of the plurality of work sheets presents a series of queries concerning hypothetical scenarios for the user.

32. The invention as in claim 31 the work sheet presenting a series of queries concerning hypothetical scenarios for the user further specifies a recalculated health care expense estimate based on responses to the queries.
